(19) United States
(12) Patent Application Publication
(10) Pub. No.: US 2006/0166070 A1
(43) Pub. Date: Jul. 27, 2006

(54) Solid oxide reversible fuel cell with improved electrode composition

(75) Inventors: Darren Hickey, Palo Alto, CA (US); Mark Cassidy, St. Andrews (GB)

Correspondence Address: FOLEY AND LARDNER LLP;SUITE 500, 3000 K STREET NW, WASHINGTON, DC, 20007, US

(73) Assignee: ION AMERICA CORPORATION

(21) Appl. No.: 11/389,282

(22) Filed: Mar. 27, 2006

Related U.S. Application Data
(63) Continuation-in-part of application No. 10/658,275, filed on Sep. 10, 2003.
(60) Provisional application No. 60/666,304, filed on Mar. 30, 2005.

(51) Int. Cl. H01M 8/12; H01M 4/90; H01M 4/88; C04B 35/64; C25B 13/04

(52) U.S. Cl. 429/33; 429/45; 264/618; 502/101; 204/295

(57) ABSTRACT

A solid oxide electrolyzer cell or a solid oxide reversible fuel cell includes a solid oxide electrolyte. It may also include at least one of a first gadolinia doped ceria interfacial layer in contact with a first side of the electrolyte and a second gadolinia doped ceria interfacial layer in contact with a second side of the electrolyte. It may also include a fuel electrode including a cermet containing nickel and one or both of a doped zirconia and gadolinia doped ceria. It may also include an oxidant electrode including an LSM and one or both of a doped zirconia and gadolinia doped ceria.

This application claims benefit of priority of U.S. Provisional Application Ser. No. 60/666,304, filed on Mar. 30, 2005, which is incorporated herein by reference in its entirety.

### BACKGROUND OF THE INVENTION

The present invention is generally directed to fuel and electrolyzer cells and more specifically to reversible solid oxide fuel and electrolyzer cells.

Fuel cells are electrochemical devices which can convert energy stored in fuels to electrical energy with high efficiencies. Electrolyzer cells are electrochemical devices which can use electrical energy to reduce a given material, such as water, to generate a fuel, such as hydrogen. The fuel and electrolyzer cells may comprise reversible cells which operate in both fuel cell and electrolysis mode. Thus, such a reversible cell will be referred to herein as a reversible fuel cell. However, it should be noted that it may also be referred to as a reversible electrolyzer cell. One type of such a reversible cell is a solid oxide reversible fuel (or electrolyzer) cell (SORFC). This cell contains a solid oxide (i.e., ceramic) electrolyte. Some reversible fuel cells reduce a previously oxidized fuel (such as water generated from hydrogen during the fuel cell mode) to an unoxidized fuel (such as hydrogen) using electrical energy as an input in the electrolysis mode. Sometimes these types of reversible cells are referred to as “regenerative” cells. However, in other cases, the term “regenerative” is used synonymously with “reversible” and the term “regenerative” does not imply reducing a previously oxidized fuel in the electrolysis mode.

The SORFC generates electrical energy and reactant product (i.e., oxidized fuel) from fuel and oxidizer in a fuel cell or discharge mode and generates the fuel and oxidant using electrical energy in an electrolysis or charge mode. The SORFC contains a ceramic electrolyte, an oxidant electrode and a fuel electrode. The electrolyte may be yttria stabilized zirconia (“YSZ”). The oxidant electrode is exposed to an oxidizer, such as air, in the fuel cell mode and to a generated oxidant, such as oxygen gas, in the electrolysis mode. The oxidant electrode may be made of a ceramic material, such as lanthanum strontium manganite (“LSM”) having a formula (La,Sr)MnO₃ or lanthanum strontium cobaltite (“LSCo”) having a formula (La,Sr)CoO₃. The fuel electrode is exposed to a fuel, such as hydrogen gas, in a fuel cell mode and to water vapor (i.e., either water vapor from water generated during the fuel cell mode or water vapor from another source) in the electrolysis mode. Since the fuel electrode is exposed to water vapor, it is usually made entirely of a noble metal or contains a large amount of noble metal which does not oxidize when exposed to water vapor. For example, the fuel electrode may be made of platinum.

However, the noble metals are expensive and increase the cost of the fuel cell. Furthermore, SORFC oxidant electrodes are sometimes prone to delamination while fuel electrodes may be prone to degradation.

### SUMMARY

A solid oxide electrolyzer cell or a solid oxide reversible fuel cell includes a solid oxide electrolyte. It may also include at least one of a first gadolinia doped ceria interfacial layer in contact with a first side of the electrolyte and a second gadolinia doped ceria interfacial layer in contact with a second side of the electrolyte. It may also include a fuel electrode including a cermet containing nickel and one or both of a doped zirconia and gadolinia doped ceria. It may also include an oxidant electrode including an LSM and one or both of a doped zirconia and gadolinia doped ceria.

### BRIEF DESCRIPTION OF THE DRAWING

FIG. 1 shows a schematic cross sectional view of a solid oxide reversible fuel cell according to a preferred embodiment of the present invention. The drawing is not to scale.

### DETAILED DESCRIPTION OF THE PREFERRED EMBODIMENTS

In a first embodiment of the invention, the inventors realized that electrode delamination in a solid oxide electrolyzer cell or solid oxide reversible fuel cell may be reduced if an interfacial layer is provided between the electrolyte and the electrode. Preferably, the interfacial layer comprises a gadolinia doped ceria (“GDC”) layer. The interfacial layer prevents or reduces delamination of the electrode from the electrolyte. Thus, the interfacial layer may be considered a part of the electrolyte or an intervening layer located between the electrolyte and the electrode.

The interfacial layer may be located between the fuel electrode and the electrolyte to prevent or reduce fuel electrode delamination. Alternatively, the interfacial layer may be located between the oxidant electrode and the electrolyte to prevent or reduce oxidant electrode delamination. Preferably a first interfacial layer is located between the fuel electrode and the electrolyte and a second interfacial layer is located between the oxidant electrode and the electrolyte.

In a second embodiment of the invention, the inventors realized that anodic degradation of the fuel electrode of the above mentioned cell may be reduced if the fuel electrode comprises a cermet comprising nickel and one or both of a doped zirconia and gadolinia doped ceria. The use of a nickel with gadolinia doped ceria and/or a doped zirconia avoids the use of expensive noble metals in the electrodes thus reducing the cost of the device. However, if desired, other materials, including noble metals, may be added to the fuel electrode.

In a third embodiment of the invention, the oxidant electrode of the above mentioned cell comprises LSM and one or both of GDC and a doped zirconia. For example, the oxidant electrode comprises an active layer comprising LSM and scandia stabilized zirconia (“SSZ”) or LSM, yttria stabilized zirconia (“YSZ”) and GDC, and a current collector layer comprising LSM or another conductive perovskite material, such as LSCo. The active layer is preferably located between the electrolyte and the current collector layer.

The features of the first, second and third embodiments of the invention may be used in any combination. For example, the fuel and/or oxidant electrode materials and the interfacial layer(s) described above may be used in any suitable combination either together or separately.

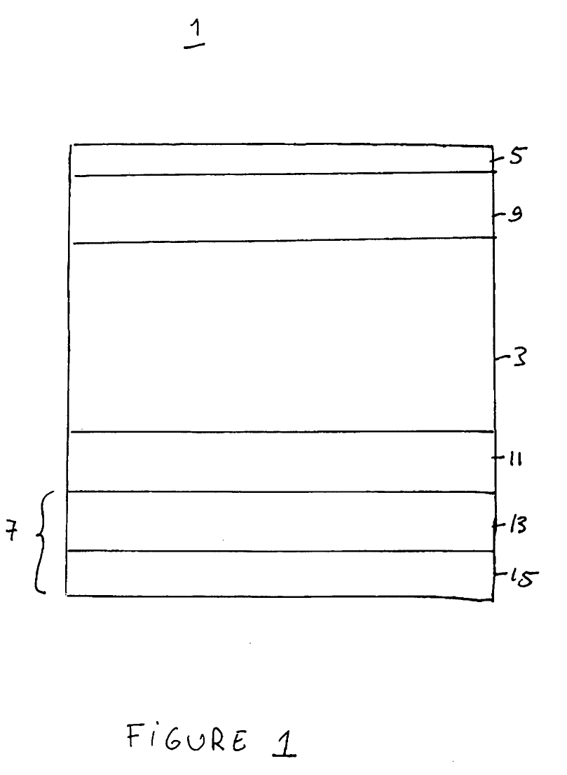

FIG. 1 shows an exemplary solid oxide electrolyzer cell according to the first through third embodiments of the present invention. This cell is preferably operated reversibly (i.e., it comprises a solid oxide reversible fuel cell). The cell 1 contains an electrolyte 3, a fuel electrode 5 and an oxidant electrode 7. Preferably a first interfacial layer 9 is located between the fuel electrode 5 and the electrolyte 3. Preferably a second interfacial layer 11 is located between the oxidant electrode 7 and the electrolyte 3.

The electrolyte 3 may comprise any suitable ceramic solid oxide electrolyte, such as a doped zirconia. For example, the electrolyte 3 may comprise a yttria or scandia stabilized zirconia or a blend of doped zirconias or other ceramic materials, such as a blend of SSZ and 3 molar percent yttria YSZ, for example. Furthermore, if desired, the electrolyte 3 may comprise multiple sub-layers of different solid oxide ceramic materials.

As noted above, either the first or the second interfacial layer 9, 11 may be used alone or in combination with the other interfacial layer. Preferably the first and second interfacial layers 9, 11 comprise gadolinia doped ceria. Interfacial layers may contain any suitable composition of gadolinia doped ceria, such as layers containing at least 5 molar percent gadolinia, such as about 5 to about 20 molar percent gadolinia. For example, the gadolinia doped ceria may contain 10% gadolinia and 90% ceria.

In a second embodiment of the invention, the fuel electrode 5 may comprise a cermet containing nickel and one or both of a doped zirconia, such as YSZ, and gadolinia doped ceria. The fuel electrode 5 may be made from a starting material which contains at least 50% nickel oxide, such as 60 to 70% nickel oxide, and the remainder GDC and/or doped zirconia. For example, the starting material for the fuel electrode may comprise 30 to 40% of GDC and/or doped zirconia, such as 15 to 20% GDC and 15 to 20% doped zirconia. Preferably, this starting material for the fuel electrode comprises a cermet containing 65% nickel oxide, 17.5% yttria stabilized zirconia and 17.5% gadolinia doped ceria. Any suitable gadolinia doped ceria may be used. For example 10 to 20% gadolinia GDC may be used. Any suitable doped zirconia may be used. For example, yttria stabilized zirconia, such as 3 or more molar percent, preferably 8 to 10 molar percent yttria YSZ, may be used. If desired, instead of or in addition to YSZ, the doped zirconia may comprise scandia stabilized zirconia, ceria stabilized zirconia (“CSZ”) or a combination of yttria, scandia and/or ceria stabilized zirconia. For example, the doped zirconia may comprise 3 to 15, preferably 8 to 10 molar percent scandia, and 0.25 to 3, preferably 1 to 2 molar percent ceria stabilized zirconia.

The cermet starting material is then reduced by being annealed in a reducing atmosphere, such as in a hydrogen or a forming gas containing atmosphere, where the nickel oxide is reduced to nickel. After the reducing anneal, the final fuel electrode composition contains nickel, and one or both of the doped zirconia (i.e., YSZ, CSZ and/or SSZ) and/or the gadolinia doped ceria. The reducing anneal may be conducted during or upon completion of the manufacture of the cell or by the end user of the cell during the initial operation of the cell.

If desired, additional layers may be added to the fuel electrode, such as a contact or current collector layer. For example, a nickel or nickel oxide current collector layer may be provided on the fuel cermet. The current collector layer may be formed as a thin film deposited as an ink or as a nickel or nickel oxide mesh. If the current collector layer comprises nickel oxide, then it may be reduced to nickel during the anneal in a reducing atmosphere.

In a third embodiment of the invention, the oxidant electrode 7 preferably comprises the active layer 13 and the current collector layer 15.

The active layer 13 may comprise an electrically conductive ceramic material, such as LSM, and an electrically insulating ceramic material, such as gadolinia doped ceria and/or a doped zirconia, such as yttria, ceria and/or scandia stabilized zirconia. For example layer 13 may comprise at least 40% of the conductive ceramic material, for example between 70 and 90% LSM, and at least 10% insulating ceramic material, such as between 5 and 15% gadolinia doped ceria and between 5 and 15% doped zirconia, such as YSZ, SSZ and/or CSZ. Alternatively, the active layer 13 may comprise between 40 and 65%, preferably between 50 and 55% LSM and between 35 and 60%, preferably 45 to 50% SSZ.

Any suitable gadolinia doped ceria and doped zirconia may be used. For example, the gadolinia doped ceria may comprise 10 or more percent gadolinia, such as 10 to 20 percent gadolinia. Any suitable doped zirconia may be used in layer 13, such as 3 or more molar percent, preferably 8 to 10 molar percent yttria, 3 to 15, preferably 8 to 10 molar percent scandia, and/or 0.25 to 3, preferably 1 to 2 molar percent ceria stabilized zirconia. The LSM may comprise A-site deficient LSM where there is less than one A-site ion (i.e., La and Sr) for each one manganese ion and for each three oxygen ions. Thus, the preferred ratio of the A-site ion (i.e., La and Sr) to manganese to oxygen is 0.9 to 0.99:1:3, such as 0.95 to 0.98:1:3. Alternatively, the LSM may comprise a “stoichiometric” LSM, where this ratio is 1:1:3. The A-site ion may comprise any suitable La to Sr ratio, such as 0.6 to 0.9:0.1 to 0.4, for example, 0.7 to 0.8:0.2 to 0.3. Thus, the LSM may be written as (LaₓSr₁₋ₓ)_{y}MnO₃, where 0.6≦x≦0.9 and 0.9≦y≦1.

The current collector layer 15 preferably comprises LSM, such as either the A-site deficient or “stoichiometric” LSM. Any other suitable conductive current collector layer may be used instead, such as LSCo. The use of conductive ceramic layers 13 and 15 in the oxidant electrode 7 reduces or eliminates the use of expensive noble metals.

As noted previously, the above described fuel electrode 5 may be used with or without the interfacial layer 9. Furthermore this fuel electrode may be used with any suitable oxidant electrode composition, such as LSM or LSCo, if desired. Likewise the oxidant electrode 7 described above may be used with any suitable fuel electrode composition such as a nickel and yttria stabilized zirconia cermet and also with or without the interfacial layer 11. Furthermore the interfacial layers 9 and/or 11 may be used with any other suitable fuel electrode and oxidant electrode compositions such as LSM or LSCo, and nickel and yttria stabilized zirconia cermet fuel electrodes.

It should be noted that the cell 1 illustrated in FIG. 1 is preferably used in a fuel or electrolyzer cell stack which includes a plurality of electrically connected cells and other components, such as gas separator/interconnect plates, seals and electrical contacts. Each gas separator/interconnect plate contacts the fuel electrode 5 and current collector layer 15 of adjacent cells. The stack is preferably part of a larger fuel and/or electrolyzer cell system which contains one or more stacks and balance of plant components. Furthermore, the fuel electrode which contains little or no noble metals may be maintained in a sufficient reducing atmosphere when the cell operates in the electrolysis mode to prevent the fuel electrode from oxidizing, as described in U.S. patent application Ser. No. 10/658,275 filed on Sep. 9, 2003 and incorporated herein by reference in its entirety.

The above described cell may be made by any suitable method. In one exemplary method, the electrode and interfacial layers are coated on the opposite sides of the electrolyte as mixed inks made from powders and then fired at any suitable temperature. For example the gadolinia doped ceria interfacial layers 9 and 11 are coated on opposite major surfaces of the electrolyte 3. Then the fuel electrode 5 starting material comprising nickel oxide and the ceramic material(s), such as yttria stabilized zirconia and gadolinia doped ceria, for example, is coated onto the interfacial layer 9 and then fired at between 1300 and 1400 degrees Celsius in air, such as at 1350 degrees Celsius in air. Then the oxidant electrode layers 13 and 15 are coated sequentially onto the interfacial layer 11 in this order. Then, the whole fuel cell is fired at between 1150 and 1250 degrees Celsius in air, such as at 1200 degrees Celsius in air. Any suitable thicknesses may be used for layers 5, 9, 11, 13 and 15 depending on the overall dimensions of the fuel cell. If desired, additional materials may be used in the inks such as dispersants, binders, carriers, etc, which are evaporated during the firing steps.

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

What is claimed is:

1. A solid oxide electrolyzer cell or a solid oxide reversible fuel cell comprising a gadolinia doped ceria interfacial layer located between a solid oxide electrolyte and an electrode.

2. The cell of claim 1 wherein the interfacial layer is located between the electrolyte and a fuel electrode.

3. The cell of claim 1 wherein the interfacial layer is located between the electrolyte and an oxidant electrode.

4. The cell of claim 1 wherein a first interfacial layer is located between the electrolyte and a fuel electrode and a second interfacial layer is located between the electrolyte and an oxidant electrode.

5. The cell of claim 1 wherein:
a fuel electrode of the cell comprises a cermet comprising nickel, doped zirconia, and gadolinia doped ceria;
an oxidant electrode of the cell comprises an active layer comprising LSM and scandia stabilized zirconia or an active layer comprising LSM, gadolinia doped ceria, and a doped zirconia;
the interfacial layer comprises 10 to 20% gadolinia doped ceria layer; and
the electrolyte comprises a stabilized zirconia.

6. The cell of claim 1 wherein the cell comprises a solid oxide reversible fuel cell.

7. The cell of claim 1 wherein the cell comprises a solid oxide electrolyzer cell.

8. A solid oxide electrolyzer cell or a solid oxide reversible fuel cell, comprising:
a solid oxide electrolyte;
a fuel electrode; and
an oxidant electrode;
wherein the fuel electrode comprises a cermet comprising nickel and at least one of gadolinia doped ceria or doped zirconia.

9. The cell of claim 8 wherein the cermet is made by providing a nickel oxide, and the at least one of doped zirconia and gadolinia doped ceria starting material and then reducing the starting material to reduce the nickel oxide to nickel.

10. The cell of claim 8 wherein:
the fuel electrode comprises a cermet comprising nickel and both of the gadolinia doped ceria and the doped zirconia;
the doped zirconia in the fuel electrode cermet is selected from at least one or YSZ, SSZ or CSZ; and
the gadolinia doped ceria in the fuel electrode cermet comprises 10 to 20% gadolinia doped ceria.

11. The cell of claim 10 wherein the fuel electrode cermet comprises between 60 and 70% nickel, between 15 and 20% yttria stabilized zirconia, and between 15 and 20% gadolinia doped ceria.

12. The cell of claim 8, further comprising:
a gadolinia doped ceria interfacial layer located between the fuel electrode and the electrolyte; and
the oxidant electrode comprises an active layer comprising LSM and scandia stabilized zirconia and an LSM current collector.

13. The cell of claim 8 wherein the cell comprises a solid oxide reversible fuel cell.

14. The cell of claim 8 wherein the cell comprises a solid oxide electrolyzer cell.

15. A solid oxide electrolyzer cell or a solid oxide reversible fuel cell comprising:
a solid oxide electrolyte;
a fuel electrode; and
an oxidant electrode;
wherein the oxidant electrode comprises an active layer comprising LSM and at least one of doped zirconia and GDC.

16. The cell of claim 15 wherein the oxidant electrode further comprises an LSM current collector layer in contact with the active layer.

17. The cell of claim 15 wherein the active layer comprises both the doped zirconia and the gadolinia doped ceria.

18. The cell of claim 17 wherein:
the active layer comprises 70 to 90% LSM, 5 to 15% yttria stabilized zirconia and 5 to 15% gadolinia doped ceria; and
the gadolinia doped ceria comprises 10 to 20% gadolinia doped ceria and the yttria stabilized zirconia comprises 8 to 10 % yttria stabilized zirconia.

19. The cell of claim 15 wherein the active layer comprises LSM and scandia stabilized zirconia.

20. The cell of claim 19 wherein the active layer comprises 40 to 65% LSM and 35 to 60% scandia stabilized zirconia.

21. The cell of claim 19 wherein the active layer comprises 50 to 55% A-site deficient LSM and 45 to 50% scandia stabilized zirconia.

22. The cell of claim 15 wherein the cell comprises a solid oxide reversible fuel cell.

23. The cell of claim 15 wherein the cell comprises a solid oxide electrolyzer cell.

24. A method of making a solid oxide fuel cell comprising:
forming a first gadolinia doped ceria interfacial layer on a first side of a solid oxide electrolyte;
forming a second gadolinia doped ceria interfacial layer on a second side of the electrolyte;
forming a fuel electrode on the first gadolinia doped ceria interfacial layer;
firing the fuel electrode;
forming an oxidant electrode on the second gadolinia doped ceria interfacial layer; and
firing the oxidant electrode.

25. The method of claim 24 wherein:
the fuel electrode is fired at between 1300 and 1400 degrees Celsius in air;
the oxidant electrode is fired at between 1150 and 1250 degrees Celsius in air;
the step of forming the fuel electrode comprises screen printing mixed inks made from powders on the first interfacial layer;
the step of forming the fuel electrode comprises forming a nickel oxide, doped zirconia, and gadolinia doped ceria layer and reducing the nickel oxide to nickel to form a cermet comprising nickel, doped zirconia and gadolinia doped ceria;
the step of forming the oxidant electrode comprises forming an active layer comprising an LSM and yttria or scandia stabilized zirconia on the second interfacial layer, and forming an LSM current collector layer on the active layer;
the steps of forming and firing the fuel electrode occur after the steps of forming the first and the second interfacial layers; and
the steps of forming and firing the oxidant electrode occur after the step of firing the fuel electrode.
